(19) United States
(12) Patent Application Publication
(10) Pub. No.: US 2017/0121576 A1
(43) Pub. Date: May 4, 2017

(54) Stimuli Responsive Adhesives

(71) Applicant: Avery Dennison Corporation, Glendale, CA (US)

(72) Inventors: Eric L. BARTHOLOMEW, Mill Hall, PA (US); William L. BOTTORF, Mill Hall, PA (US); Christopher L. LESTER, Kingsport, TN (US); Nagarajan SRIVATSAN, Diamond Bar, CA (US)

(21) Appl. No.: 15/343,544

(22) Filed: Nov. 4, 2016

Related U.S. Application Data
(60) Provisional application No. 62/250,557, filed on Nov. 4, 2015.

(51) Int. Cl. C09J 153/00; C09J 7/02; C08F 293/00

(52) U.S. Cl. CPC C09J 153/005; C08F 293/005; C09J 7/0217; C09J 7/0285; C08F 2438/03; C09J 2467/006

(57) ABSTRACT

Various stimuli-responsive polymers are described which exhibit changes in one or more physical properties upon exposure to a stimulus. The polymers are acrylic polymers and include particular end blocks with stimuli-responsive groups. Also described are various adhesives that include the stimuli-responsive polymers.

### CROSS-REFERENCE TO RELATED APPLICATION

The present application claims the benefit of U.S. Provisional Patent Application No. 62/250,557 filed Nov. 4, 2015, which is incorporated herein by reference in its entirety.

### FIELD OF THE INVENTION

The present invention relates to adhesives that respond to external stimuli by changing one or more properties of the adhesives.

### BACKGROUND OF THE INVENTION

Currently, the marketplace lacks a robust temperature switchable adhesive. In certain applications such as graphics or security labels, it would be desirable to have a pressure sensitive adhesive (PSA) that forms a permanent bond and then can be easily and cleanly removed upon exposure to an increase in temperature. In other applications, the converse would be desirable in which a PSA acts as a removable adhesive or non PSA at lower temperatures, and then upon exposure to an increase in temperature would change to become a permanent PSA.

### SUMMARY OF THE INVENTION

The difficulties and drawbacks associated with previously known adhesives and systems are overcome in the present invention for stimuli responsive adhesives, compositions and products comprising such adhesives and related methods involving the adhesives, compositions and products.

In one aspect, the present invention provides a stimuli-responsive polymer comprising an intermediate portion including acrylic and/or methacrylic monomers and opposite end blocks. Each end block includes a stimuli-responsive group selected from the group consisting of (i) a crystallizable side chain and (ii) an amorphous monomer having solubility parameters that are different than solubility parameters of monomers in the intermediate region. The ratio of total molecular weight of the end blocks to the molecular weight of the remaining polymer is from about 5:95 to about 40:60.

In another aspect, the present invention provides an adhesive including a stimuli-responsive polymer comprising an intermediate portion including acrylic and/or methacrylic monomers and opposite end blocks. Each end block includes a stimuli-responsive group selected from the group consisting of (i) a crystallizable side chain and (ii) an amorphous monomer having solubility parameters that are different from solubility parameters of monomers in the intermediate region. The ratio of total molecular weight of the end blocks to the molecular weight of the remaining polymer is from about 5:95 to about 40:60.

As will be realized, the invention is capable of other and different embodiments and its several details are capable of modifications in various respects, all without departing from the invention. Accordingly, the drawings and description are to be regarded as illustrative and not restrictive.

### BRIEF DESCRIPTION OF THE DRAWINGS

FIG. 1 is a graph of modulus as a function of temperature for pure behenyl acrylate end block polymer.

FIG. 2 is a graph of heat flow as a function of temperature for behenyl acrylate monomer from BASF compared to lab acrylated NACOL® 22.

FIG. 3 is a graph of heat flow as a function of temperature for block copolymers made with commercially available behenyl block copolymer and DW01-59 block copolymer.

FIG. 4 is a graph of modulus as a function of temperature for both 90/10 block copolymers comparing behenyl acrylate to NACOL® 2233.

FIG. 5 is a graph of cone and plate melt rheology (viscosity) as a function of temperature for the two 90/10 block copolymers of FIG. 4.

FIG. 6 is a graph of modulus as a function of temperature for two 70:30 block copolymers.

FIG. 7 is a graph of modulus as a function of temperature for behenyl and C-24/28 block copolymers.

FIG. 8 is a graph of absolute viscosity as a function of temperature for 85:15 C-24/28 base polymer.

FIG. 9 is a graph of absolute viscosity as a function of temperature for varying mid block compositions.

FIG. 10 is a graph of absolute viscosity as a function of temperature for behenyl and C-24/28 90:10 block copolymers.

### DETAILED DESCRIPTION OF THE EMBODIMENTS

The present invention relates to external stimuli responsive adhesives. More specifically, the invention relates to adhesives (primarily pressure sensitive adhesives) including (meth)acrylic block copolymers in which one or more blocks are composed of monomers that impart one or more stimuli responsive characteristic(s) to the adhesive. That is, as a result of the monomers, blocks of monomers, and/or their incorporation in the copolymer; the adhesive responds to external stimuli.

### Stimuli-Responsive Groups

The polymers used in the adhesives include one or more stimuli-responsive groups (SRG). The SRG is preferably introduced or incorporated in the polymer of interest by introducing one or more monomers containing the desired SRG. Preferably, the monomers containing the SRG of interest are introduced into a polymer during polymerization of the polymer. Preferably, the SRG is a crystallizable high aliphatic acrylic ester such as an aliphatic C₁₆-C₃₀ acrylic ester. Another example of a high aliphatic acrylic ester is behenyl acrylate. Alternatively, the SRG is an amorphous group, i.e., an amorphous monomer incorporated into the polymer, with solubility parameters that are different from other monomers in the polymer to cause phase separation. An example of an amorphous SRG is t-butyl acrylate. The preferred SRG's are side chain crystalline groups, also referred to herein periodically as SCC's.

In certain embodiments, the side chain crystalline groups are C₁₆ to C₁₈ aliphatic acrylic esters which constitute end blocks or end regions of the polymer. The stimuli-responsive characteristics of the polymer can be specifically tailored by adjusting the size, i.e. the molecular weight, of the end blocks relative to the molecular weight of the remaining polymer. The ratio of total molecular weight of the end blocks to the molecular weight of the remaining polymer, i.e., the regions of the polymer not including the end blocks, is preferably from about 5:95 to about 40:60, with 10:90 to 30:70 being preferred.

Polymers and their Formation

The polymers and more specifically the intermediate regions of the polymer exclusive of the end blocks, are preferably (meth) acrylic block copolymers. As previously described, the polymers comprise (i) an acrylic and/or methacrylic monomer(s), and (ii) one or more monomers that include or provide the SRG's of interest.

The acrylic polymer may be derived from acrylates, methacrylates, or mixtures thereof. The acrylates include C₁ to about C₂₀ alkyl, aryl or cyclic acrylates such as methyl acrylate, ethyl acrylate, phenyl acrylate, butyl acrylate, 2-ethylhexyl acrylate, isobornyl acrylate and functional drivatives of these acrylates such as 2-ethylhexyl acrylate, isobornyl acrylate and functional derivatives of these acrylates such as 2-hydroxy ethyl acrylate, 2-chloroethyl acrylate, and the like. These compounds typically contain from about 3 to about 20 carbon atoms, and in one embodiment about 3 to about 8 carbon atoms. The methacrylates include C₁ to about C₂₀ alkyl, aryl or cyclic methacrylates such as methyl methacrylate, ethyl methacrylate, butyl methacrylate, 2-ethylhexyl methacrylate, phenyl methacrylate, isobornyl methacrylate, and functional derivatives of these methacrylates such as 2-hydroxyethyl methacrylate, 2-chloroethyl methacrylate, and the like. These compounds typically contain from about 4 to about 20 carbon atoms, and in one embodiment about 4 to about 8 carbon atoms.

A wide array of techniques can be used to prepare the preferred embodiment polymers. For example, RAFT is a preferred method for forming the desired polymers. Generally, any living polymerization method can be used. Anionic, group transfer polymerization, any controlled radical method such as atom transfer radical polymerization (ATRP), stable free radical polymerization (SFRP) including a subset technique involving nitroxide mediated polymerization (NMP), and other techniques known in the art could be used to form the preferred embodiment polymers.

The preferred embodiment polymers have a typical molecular weight of from about 25,000 to about 300,000; preferably from about 50,000 to about 200,000; and most preferably from about 75,000 to about 150,000. The polydispersity of the preferred embodiment polymers is typically less than about 2.5, preferably less than about 2.0, and most preferably less than about 1.5. However, it will be appreciated that the present invention includes polymers having molecular weights outside of these noted ranges, and polydispersities greater than 2.5.

The preferred embodiment polymers include end regions of the polymer chain which are preferably in the form of side chain crystalline (SCC) groups. In one embodiment, a preferred polymer having a molecular weight of about 100,000 g/mole includes two opposite end blocks of 100% C₁₆-C₁₈ aliphatic groups which are preferably side chain crystalline groups, in which each group has a molecular weight of about 5,000 g/mole. The remaining intermediate portion of the polymer is formed from about 97% by weight of 2-ethyllhexyl acrylate and about 3% by weight of acrylic acid. The molecular weight of the remaining portion of the polymer is about 90,000 g/mole. In another embodiment, a preferred polymer having a molecular weight of about 100,000 g/mole includes two opposite end blocks of 100% t-butyl acrylate which are preferably amorphous end blocks, in which each group has a molecular weight of about 5,000 g/mole. The remaining intermediate portion of the polymer is formed from about 97% by weight of 2-ethylhexyl acrylate and about 3% by weight of acrylic acid. The molecular weight of the remaining portion of the polymer is about 90,000 g/mole.

The response exhibited by the polymer can include for example, a change in bulk viscoelastic properties in a cast adhesive film, or a change in solution/colloidal properties as a wet adhesive, or a combination of both. Additional examples of polymer properties that may change in response to external factors include but are not limited to gas permeability, solvent and/or chemical resistance, melt rheology, and optical properties such as opacity changes.

Temperature is the most typical stimuli for the change in bulk viscoelastic properties of an adhesive film. Additional examples of stimuli or external factors that may induce or cause a change in polymer properties include but are not limited to pH, exposure to ultraviolet (UV) radiation, and exposure to moisture.

There are two main classes of acrylic block copolymers that exhibit a marked change in bulk viscoelastic properties in a dry film. Both are phase separated block copolymers. One type of polymer which exhibits a marked change in bulk visceolastic properties are polymers in which one or more acrylic blocks include high aliphatic acrylic esters that are capable of crystallizing. These polymers typically include side chain crystalline monomers. Another type of polymer which exhibits or marked change in bulk viscoelastic properties are polymers in which one or more acrylic blocks include amorphous monomers with solubility parameters sufficiently different from the adhesive block to phase separate.

At present, there does not exist a robust pressure sensitive adhesive system that displays true stimuli responsive characteristics. True stimuli responsive characteristics are defined herein as a marked change in properties in a relatively rapid time period upon application of a stimulus as opposed to a gradual change of performance upon exposure to stimulus.

### Adhesives

The present invention includes a wide array of adhesives that utilize the stimuli-responsive polymers described herein. Preferably, the adhesives are pressure sensitive adhesives, however, it will be appreciated that the invention includes other types of adhesives. The adhesives can comprise in addition to the stimuli-responsive polymer(s), one or more components typically utilized in adhesive formulations for example thickeners, tackifiers, plasticizers, viscosity adjusters, colorants, pigments, etc.

### Applications

The present invention stimuli responsive adhesives can be used in a variety of applications. In certain embodiments, adhesives become pressure sensitive upon exposure to stimuli or become nonpressure sensitive upon exposure to stimuli.

Pressure sensitive adhesives based upon phase separated block copolymers that have at least one distinct block that undergoes a significant change with a change in temperature could be used in a variety of applications. Current technology in this area relies on statistical copolymers and typically materials that are low molecular weight additives that have a variety of shortcomings. These shortcomings include limited breadth of pressure sensitive adhesive performance, poor optical clarity, and low molecular weight residue remaining on substrates. In one aspect of the present invention, it is hypothesized that block copolymers in which the temperature switch is covalently bound could address the described shortcomings. Additionally, these types of block copolymers have the potential to be an entirely new class of hot/warm melt materials.

In addition to specific PSA applications using temperature switchable adhesives, these new materials would offer a potential processing advantage in that some of these materials would act as hot/warm melt adhesives. Due to the phase separated nature of the polymers, and coupled with low to moderate molecular weights they would have melt viscosities on the order of standard hot melt PSAs (SIS, SBC, etc). In contrast to standard hot melts, this new class of materials would have the added advantage of being entirely acrylic which would yield better heat, oxidative, and UV aging characteristics. Furthermore, because of the wide variety of acrylic monomers available, the processing temperatures would be tunable and crosslinking chemistries could be incorporated to yield better temperature performance which is a well known deficiency of current hot melt technology.

### EXAMPLES

### Example 1: Preparation of Segmented Acrylic Polymer

An acrylic copolymer with crystalline properties positioned in the segments opposite each other in a triblock polymer is prepared as follows. Into a 500 ml reactor equipped with a heating jacket, agitator, reflux condenser, feed tanks and nitrogen gas inlet, 9.93 g of ethyl acetate is charged. Monomers, initiator, and RAFT agent are added in the following amounts to generate crystalline endblocks positioned at the polymer chain ends.

36.88 g behenyl acrylate

0.71 g of dibenzyl trithiocarbonate (RAFT agent)

1.015 g of 1,1′-azo bis(cyclohexanecarbonitrile) (Vazo-88)

The reactor charge is heated to 45° C. (reactor jacket 50° C.) with a constant nitrogen purge. After the reactor charge is under constant nitrogen purge for 30 minutes, the reactor jacket is increased to 90° C. After a peak temperature of 79-81° C. is attained, the reaction conditions are maintained for 90 minutes at which point more than 80% of the monomers are consumed to generate crystalline segments of a theoretical Mₙ of 7,500 g/mole. A reagent feed mixture with an active nitrogen purge of 175.18 g ethyl acetate, 9.96 g acrylic acid, and 315.32 g butyl acrylate is added over a period of two hours to the reactor. Over the two hour reagent feed the temperature of the reaction is held at 79-81° C. The reaction conditions are maintained for 1 hour after completion of the reagent feed at which point more than 97.0% of the monomers are consumed to generate a nonreactive segment of theoretical Mₙ of 135,000 g/mole. The resulting solution polymer is then cooled to less than 70° C. and discharged from the reactor slightly warm to ensure flow.

The resulting acrylic polymer contains 87.08% butyl acrylate, 10.16% behenyl acrylate, and 2.76% acrylic acid based on 100% by weight of the acrylic polymer. The measured molecular weight (Mn) of the acrylic polymer is 76,303 (determined by gel permeation chromatography relative to polystyrene standards) and the polydispersity is 1.50.

The adhesives are coated onto 2-mil polyethylene terephthalate at 58-62 grams per square meter (gsm) and dried at 120° C. for 10 minutes. The adhesives are then subjected to 180° peel tests and shear strength as set forth below in Table 1.

TABLE 1
PSA Performance Test Methods

| Test | Condition |
|---|---|
| 180° Peel - 15 Minute Dwell | a1 |
| 180° Peel - 72 Hour Dwell | a2 |
| Shear Strength | c |

(a) Peel: sample applied to a stainless steel panel with a 5 pound roller with 1 pass in each direction. Samples conditioned and tested at 23° C.

(c) Shear: 2 kg weight with a ½ inch by 1 inch overlap. Sample applied to a stainless steel panel with a 5 pound roller with 1 pass in each direction. Samples conditioned and tested at 23° C.

TABLE 2
Results of PSA Performance Testing

| Test | Ex. 1 |
|---|---|
| (a1) 180 peel to stainless steel 15 min dwell | 4.34 |
| (lb/in) | Split Tr. |
| (a2) 180 peel to stainless steel 72 hours dwell | 4.90 |
| (lb/in) | Split Tr. |
| (c) Static Shear ½ × 1 × 2 kg (8.8 lbs/sq. inch) | 10,000+ |
| stainless (min.) | |

### Example 2

In this investigation, it was desired to synthesize and characterize side chain crystalline block copolymers for various potential uses. In addition, it was desired to understand the structure property relationship and identify potential applications for copolymers.

Side chain crystalline block copolymers have previously been made and characterized. These types of materials can be made inherently pressure sensitive and free of tackifing resins. They also show signs of exhibiting switchable behavior, and could potentially act as a heat activatable or switchable adhesive. The inherently pressure sensitive polymers are detailed as follows.

Side chain crystalline (SCC) block copolymers have been made using dibenzyltrithiocarbonate RAFT agent with the idealized A-B-A tri-block structure.

Several block copolymers were synthesized all with pure butyl acrylate mid blocks and pure behenyl acrylate end blocks at various end block sizes. These polymers were coated from warmed solvent, because they are solids at room temperature in solvent. The results of PSA testing for these materials are set forth in Table 3. The materials were all coated at 60 gsm dry coat weight and dried at 120° C. for 7 minutes.

TABLE 3
PSA Properties of Various End-Block Weight Fraction SCC Polymers

| Mid Block to | | | |
|---|---|---|---|
| End block | 15 min peel to | 72 hr peel to | ½ × 1 inch |
| weight ratio | Steel | Steel | 1 Kg shear |
| 95/5 | 5.33 | 5.38 | 3530.5 Split |
| | Complete Tr | Complete Tr | |
| 90/10 | 6.62 | 6.9 | 10000+ |
| | Complete Tr | Complete Tr | Removed |
| 80/20 | 0.96 | 0.95 | 10000+ |
| | | | Removed |

The three polymers in Table 3 encompass the preferred end block weight fraction functionalization for PSA materials. The five percent end block material exhibited transfer when peeling and also displayed splitting failure in the static shear test. The ten and twenty percent end block materials did not fail in shear testing, however the peel values for the twenty percent end block were very low, making this polymer potentially suitable for removable applications.

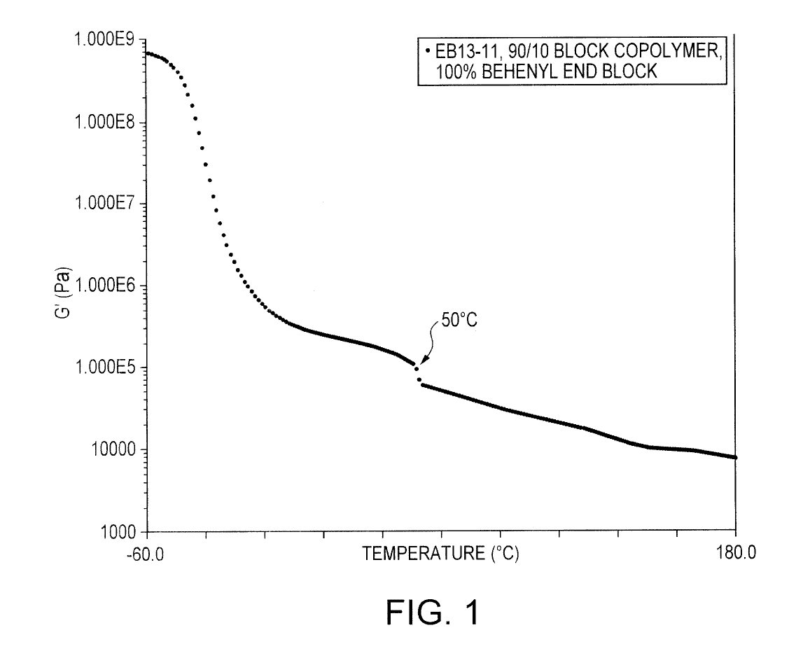

The behenyl acrylate end block composition of the polymers seen in FIG. 1 have a melting point of 50° C. after which the modulus of the polymer drops significantly due to the physical structure of the end block being lost, as seen in FIG. 1.

The melt point of the behenyl acrylate block copolymer may not be ideal for some PSA applications because some laminates could be exposed to 50° C. use temperatures, and could result in failure. The Sasol Chemical Company manufactures synthetic alcohols of various molecular weights. Initially two molecular weight alcohols were sampled from Sasol, a C20 and C22 material. Both of these alcohols have a purity of greater than 98%, which is significantly improved over the commercially available behenyl from BASF which is published to be, and have been confirmed by in-house analysis, as a mixture of C16, C18, and C22 materials.

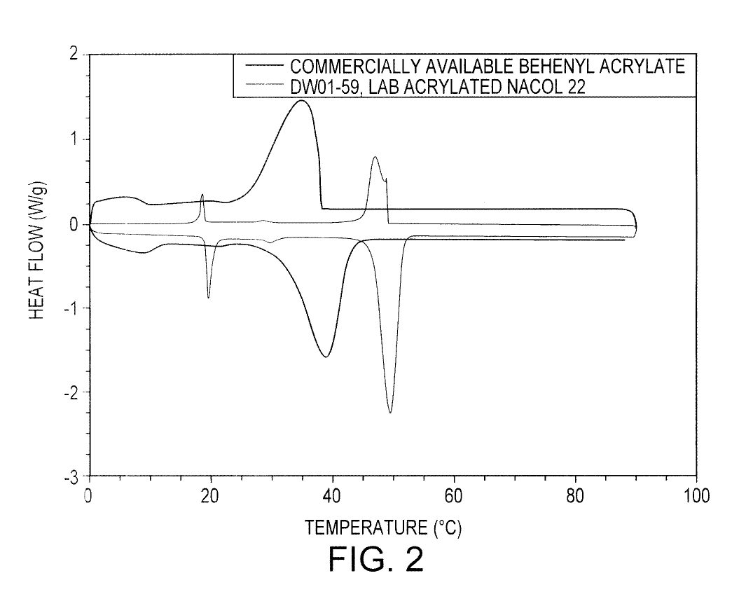

A lab process was used to transesterify the Sasol alcohols to make acrylates so that they could be evaluated in a block copolymer composition similar to the commercially available behenyl acrylate. Differential Scanning calorimetry (DSC) was then performed on the lab acrylated material compared to the commercially available behenyl. As seen in FIG. 2, a significant increase in melt point was observed with the Sasol derived acrylate.

Both of the commercially available behenyl and the DW01-59 monomers have secondary transitions at lower temperatures than the primary peak. It is not entirely clear what is causing these other transitions, but some possibilities could be inhibitor, residual starting material, or some conformational arrangement of the monomer that allows for a transition of the amorphous segment of the material.

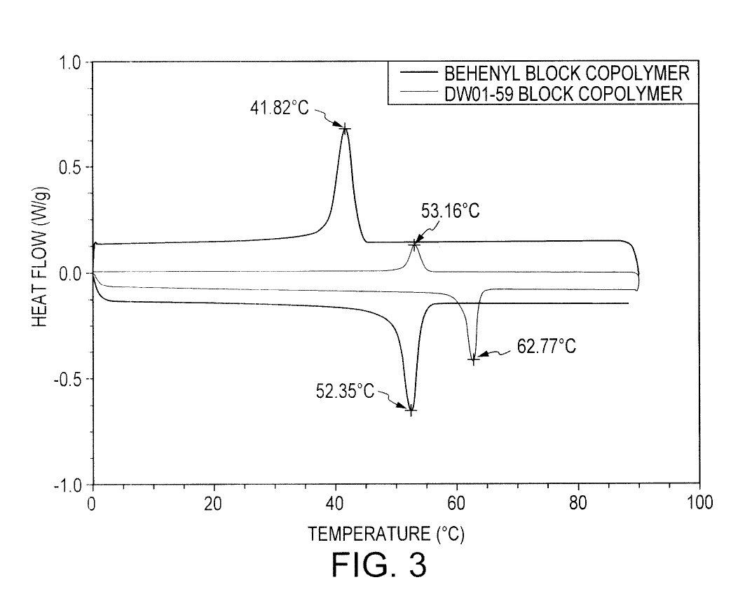

For direct comparison purposes, block copolymers were synthesized using both the commercially available behenyl and the DW01-59 at a 70/30 weight ratio of mid block to end block. DSC plots of these two polymers can be seen in FIG. 3.

Both in the heating and cooling sets of the DSC results, the DW01-59 containing block copolymer exhibited approximately about a 10 degree increase in melting point over the commercially available behenyl polymer, potentially extending the use temperature of an adhesive of this type.

Sasol supplied samples of their acrylated C22 (NACOL® 2233 Ester), and an acrylated mixture of C24 and C28 (NACOL® 242833 Ester). The C22 physically resembled the DW produced monomer, however the C24, C28 mixture had a brown appearance. Sasol indicated that their sample of 242833 may have significantly oxidized during functionalization.

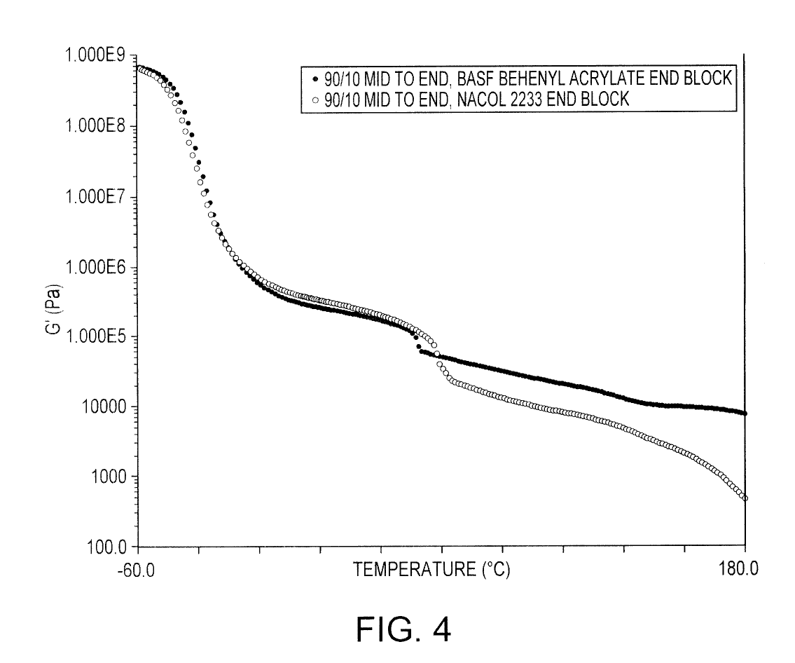

Two block copolymers were made at the 90/10 weight ratio of mid block to end block for a PSA performance comparison. These materials had a mid block composition of 97 pph butyl acrylate and 3 pph acrylic acid for potential ability to crosslink the polymers. FIG. 4 displays the modulus curves for the two 90/10 PSA type block copolymers with different melt point end blocks.

The 10 degree increase in melt point can still be seen with the 90/10 block copolymers using the NACOL® 2233 monomer. Interestingly, the block polymer containing the NACOL® 2233 end blocks had a significantly lower modulus after the melt, potentially indicating this polymer may have a lower melt viscosity.

Both of these polymers were solids at room temperature in solvent. As a result, a dilution study was performed to evaluate how dilute and what solvents would be ideal from maintaining liquid characteristics. The dilution data and the resulting PSA testing of these samples can be seen in Table 4.

TABLE 4
PSA and Dilution Data for the 90/10 Block Copolymers

| | | | Dilu- | Room | | | | | | | | | | | | | | | |
|---|---|---|---|---|---|---|---|---|---|---|---|---|---|---|---|---|---|---|---|
| | As | Di- | tion | Temp | 180 deg SS peels | | | | | | 180 deg PP peels | | | | | | | | ½″ × |
| End | made | luted | sol- | vis- | 15 | | 24 | | 72+ | | 15 | | 24 | | 72+ | | | | 1″ 1 Kg |
| Block | solids | solids | vent | cosity | min | mof | hr | mof | hr | mof | min | mof | hr | mof | hr | mof | WPI | mof | shears |
| Behenyl | 47 | 45 | Hep- | 866 | 5.65 | tr | 5.85 | tr | 5.49 | tr | 0.37 | z | 0.37 | z | 0.49 | z | 2.7 | cr | 10000 |
| Acry- | | | tane | | | | | | | | | | | | | | | | |
| late | 47 | 45 | Tol- | 1166 | 5.55 | tr | 5.67 | tr | 5.45 | tr | 0.38 | z | 0.39 | z | 0.49 | z | 2.9 | cr | 10000 |
| | | | uene | | | | | | | | | | | | | | | | |
| | 47 | 45 | 50:50 | 868 | 5.50 | tr | 5.72 | tr | 5.52 | tr | 0.34 | z | 0.35 | z | 0.47 | z | 2.7 | cr | 10000 |
| Nacol | 58 | 42.5 | Hep- | 448 | 1.81 | st | 3.34 | st | 4.23 | tr | 0.41 | z | 0.42 | z | 0.77 | z | 2.6 | cr | 10000 |
| Ester | | | tane | | | | | | | | | | | | | | | | |
| 2233 | 58 | 42.5 | Tol- | 874 | 4.65 | tr | 4.67 | tr | 4.58 | tr | 0.82 | z | 0.32 | z | 0.41 | z | 2.7 | cr | 10000 |
| | | | uene | | | | | | | | | | | | | | | | |
| | 58 | 42.5 | 50:50 | 574 | 3.76 | tr | 4.72 | tr | 4.52 | tr | 0.90 | z | 0.31 | z | 0.41 | z | 2.6 | cr | 10000 |

The choice of dilution solvent appears to have little effect on the behenyl polymer PSA data, however heptane appears to be more effective in reducing viscosity. The polymer containing NACOL® 2233 has a significant PSA and viscosity response to dilution solvent. This difference between the two polymers' response to dilution is likely due to the amount of dilution in each. The behenyl polymer was lowered 2% solids via dilution, while the NACOL® 2233 containing polymer was diluted by 15.5%. The final solids content of these dilutions was determined by where the polymer remained a liquid at 25° C. The difference in PSA performance becomes less significant with dwell time, indicating a thermodynamic equilibrium is being reached. This is somewhat unexpected considering that all of the samples were coated and oven dried for 7 minutes at 120° C., which is well above the melt point of the end blocks. Both polymers had zippy peels to polypropylene, likely due to the fairly polar butyl acrylate based mid block composition.

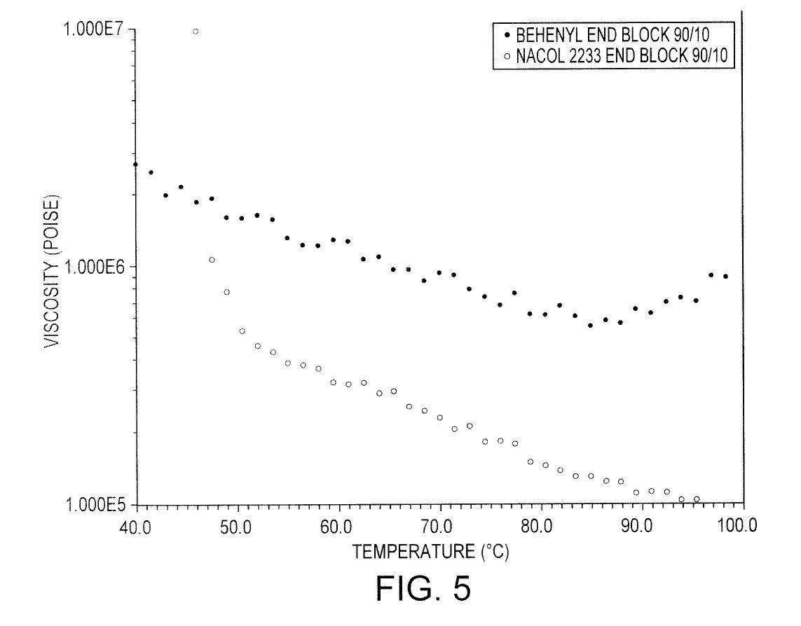

Cone and Plate melt rheology was performed on these samples to confirm that the lower modulus after the melt for the NACOL® 2233 containing polymer as seen in FIG. 4 would result in lower melt viscosity. The melt viscosity was run from a starting point of 40° C. to 100° C., the limit of the instrument. The melt rheology data can be seen in FIG. 5.

The NACOL® 2233 containing polymer does in fact have a lower melt viscosity than the behenyl polymer. Because the architecture for these polymers was designed by weight fraction and the NACOL® material is a pure C22 monomer having a higher molecular weight than the behenyl acrylate, the degree of polymerization (Dₚ) for the NACOL® polymer is lower, which could result in the lower melt rheology.

Inherently pressure sensitive all acrylic block copolymers have been demonstrated. The melt point, and potentially the melt rheology of these materials can be changed through the use of higher molecular weight side chain crystalline monomers. These materials could potentially be warm melt processable.

### Example 3

In this investigation, further efforts were undertaken to synthesize and characterize side chain crystalline block copolymers for various potential uses. It was also desired to understand structure property relationship and identify potential applications.

Side chain crystalline block copolymers have previously been made, characterized and reported on previously. These types of materials can be made inherently pressure sensitive and free of tackifing resins. Additionally they could potentially be used to make heat activatable adhesive and switchable pressure sensitive adhesives. Melt rheology and performance data from heat activatable and switchable prototypes will be detailed herein.

Side chain crystalline (SCC) block copolymers have been made using dibenzyltrithiocarbonate RAFT agent with the idealized A-B-A tri-block structure.

Previous side chain crystalline inherently pressure sensitive adhesives made utilizing the A-B-A block co-polymer architecture exhibited very light adhesion at an 80:20 weight ratio of mid block to end block. Two block copolymers were synthesized at 70:30 weight fraction of mid block to end block. One copolymer comprised a mid block of butyl acrylate and acrylic acid at 95:5 based on weight. The other copolymer contained butyl acrylate and acrylic acid at 90:10 weight fraction. The level of acrylic acid in the mid block was varied to change the T_{g}, and potentially the rheology of the material in the melt.

These two polymers were cast from warm solvent and dried on 2 mil PET face stock at 60 grams per square meter. Room temperature peel performance was evaluated on stainless steel. Additionally the materials were applied to stainless steel test panels at 80° C., allowed to dwell at 80° C. for 1 hour, and then cooled to room temperature and dwelled for an additional 24 hours. The room temperature and 80° C. applied peel data reporting in pounds per inch can be seen in Table 5.

TABLE 5
Room Temperature and 80 Applied Peel Performance of
Two 70:30 Block Copolymers.

| Mid Block | 24 hr Room | 80° C. Applied Temp, |
|---|---|---|
| Acid Level | Temp Peel | 24 hr Dwell |
| 5 | 0.06 | 3.75 |
| 10 | 0.12 | 4.35 |

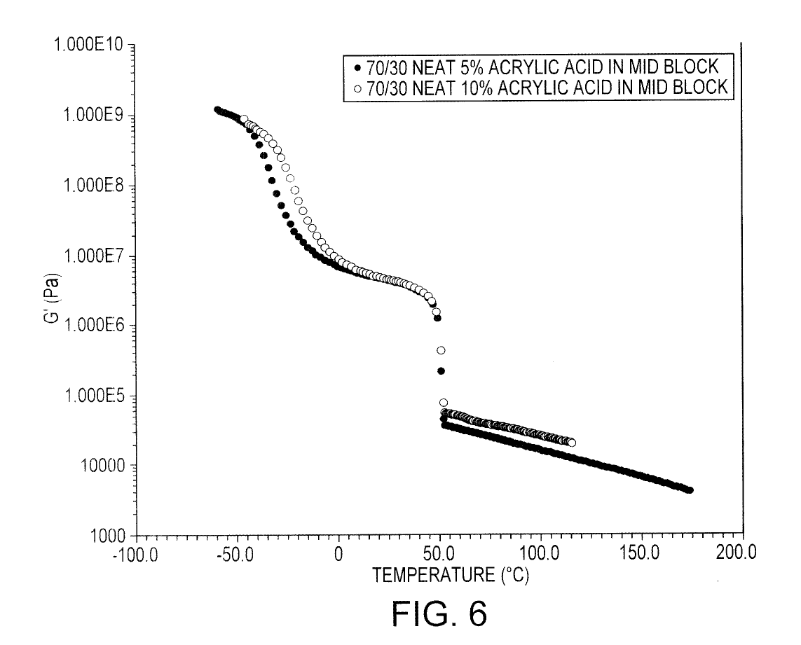

Both polymers exhibited very light adhesion to steel when applied at room temperature. However, the polymers when applied above the melting point of the end blocks and then allowed to cool to room temperature, exhibited a permanent type peel force. The modulus as a function of temperature for both polymers can be seen in FIG. 6.

As expected, the higher acid level in the mid block has no effect on the melt point, although it does shift the T_{g} before the melt and raise the modulus after the melt. This change in modulus with acid level may be useful when designing a heat activatable adhesive.

In addition to heat activatable prototypes, temperature switchable materials have also been made in which a significant loss of adhesion is demonstrated upon heating. The melt temperature of these side chain crystalline block copolymers can be raised by the use of longer side chain acrylic esters in place of behenyl acrylate.

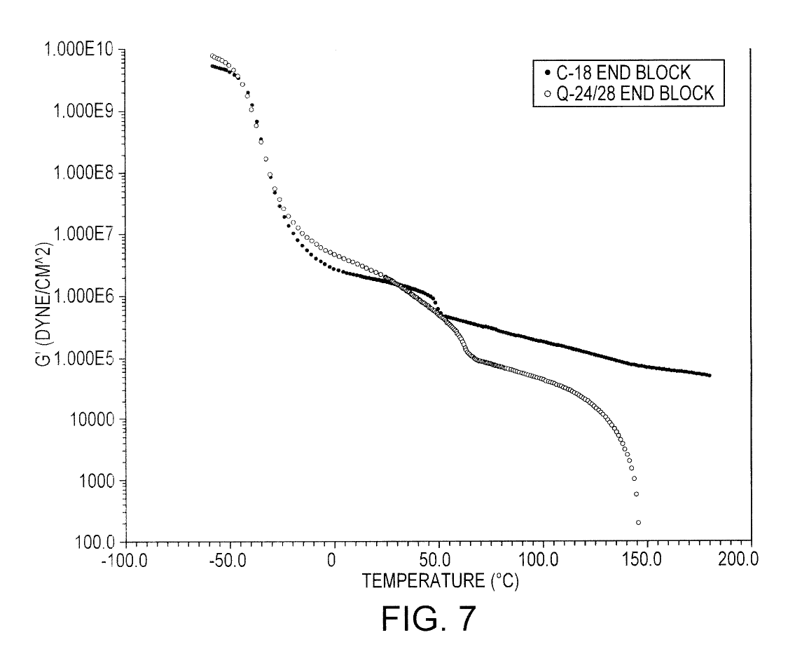

Two block copolymers were prepared to demonstrate this increase in melt temperature and to generate a higher melting point switchable prototype. The two block copolymers were both 90:10 by weight mid block to end block. One of the copolymers contained a pure behenyl acrylate end block, while the other was pure C-24/28 acrylate supplied by Sasol Chemical. The modulus as a function of temperature for these two polymers is shown in FIG. 7.

The melt point of the block copolymer containing the C-24/28 monomer is shifted to approximately 60° C., and interestingly the modulus after the melt appears to be dramatically reduced starting at around 130° C. A series of block copolymers containing the C-24/28 acrylate monomer were made with increasing levels of end block weight fraction to reduce the peel value and prevent splitting when testing on steel. Aluminum acetyl acetonate (AAA) was also added to the materials as an alternative to increasing weight fraction of the crystalline portion in an attempt to make a wash away prototype. Room temperature and elevated temperature peel data for these materials at 15-18 grams per square meter can be seen in Table 6. The elevated peel testing was applied at room temperature, dwelled for 24 hours, and then dwelled at the reported testing temperature for 5 minutes prior to measuring the peel force. All peel results in FIG. 7 exhibited splitting failure unless otherwise noted.

TABLE 6
Room Temperature and Elevated Temperature Peel Data For C-24/28 Containing Block Copolymers

| Mid Block:End | % AAA | 15 min peel | | 24 hour peel | | | | |
|---|---|---|---|---|---|---|---|---|
| Block Weight ratio | crosslinker | to Steel | | to Steel | 40° C. peel | 50° C. peel | 60° C. peel | 70° C. peel |
| 90:10 | 0 | 2.17 | | 2.14 | 0.44 | 0.12 | 0.06 | 0.02 |
| 90:10 | 0.05 | 2.53 | | 2.49 | 0.54 | 0.18 | 0.06 | 0.06 |
| 90:10 | 0.1 | 0.81 | | 2.35 | 0.74 | 0.24 | 0.07 | 0.04 |
| 90:10 | 0.3 | 0.14 | clean | 0.19 clean | NA | NA | NA | NA |
| 85:15 | 0 | 0.83 | clean | 1.92 clean | 0.23 | 0.06 | 0.07 | 0.03 |
| 85:15 | 0.05 | 0.68 | clean | 1.03 clean | 0.25 | 0.12 | 0.06 | 0.03 |
| 85:15 | 0.1 | 0.25 | clean | 0.44 clean | 0.21 | 0.10 | 0.07 | 0.05 |
| 85:15 | 0.3 | 0.13 | clean | 0.19 clean | NA | NA | NA | NA |
| 80:20 | 0 | 0.65 | clean | 0.90 clean | 0.16 | 0.03 | 0.03 | 0.03 |
| 80:20 | 0.1 | 0.2 | clean | 0.26 clean | 0.03 clean | 0.01 clean | 0.02 clean | 0.04 |

The 80:20 block copolymer sample exhibited clean peel at room temperature and clean peel at elevated temperature in the case of the sample with 0.1% cross-linker. Both of the 80:20 samples were then coated onto the polypropylene face stock for further evaluation.

### Melt Viscosity:

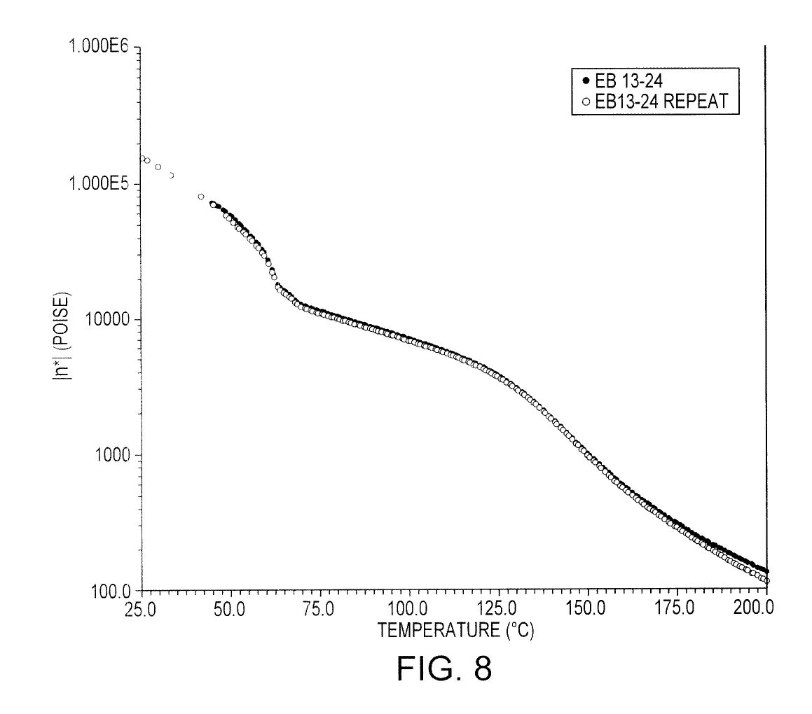

An analysis method has been identified that will enable the use of an AR-2000 rheometer to conduct melt viscosity measurements. After a series of test parameters were identified, a simple reproducibility study was performed to ensure the same data can be generated from the same sample in multiple tests. Repeat test data is shown in FIG. 8, which is a plot of absolute viscosity as a function of temperature for the 85:15 C-24/28 base polymer described above.

The method used for the melt viscosity experiments is fairly reproducible and will be used to measure melt viscosities of various materials.

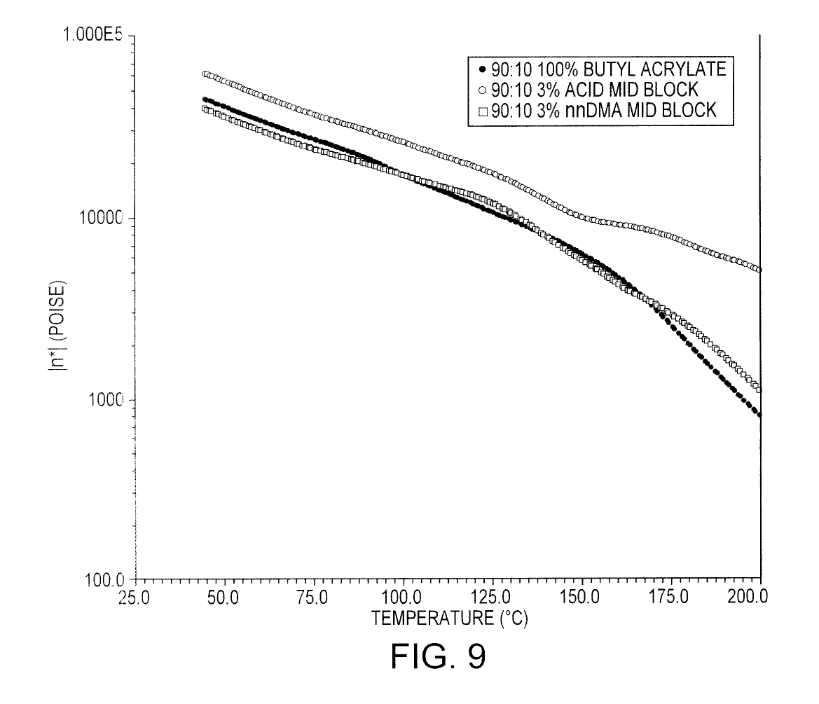

Acrylic acid has been used in the mid block compositions to enhance phase separation, and provide adhesion promotion. The use of acid in the mid block could have a negative impact on the viscosity of the material in the melt. A study was conducted to identify the viscosity effects of the acrylic acid in the mid block. Three polymers were made at a 90:10 weight fraction of end block to mid block, with 100% butyl acrylate, 3% acrylic acid, and 3% nn-dimethylacrylamide to evaluate effects on melt viscosity. Absolute viscosity as a function of temperature for these three polymers is shown in FIG. 9.

The acrylic acid containing mid block exhibits a higher viscosity throughout the temperature range of the investigation. Interestingly, the nn-DMA containing material is similar in viscosity to the pure butyl acrylate mid block with some deviation at the higher temperatures. This may suggest that nn-DMA can be used to enhance phase separation and promote adhesive capability without significant negative impact on melt viscosity.

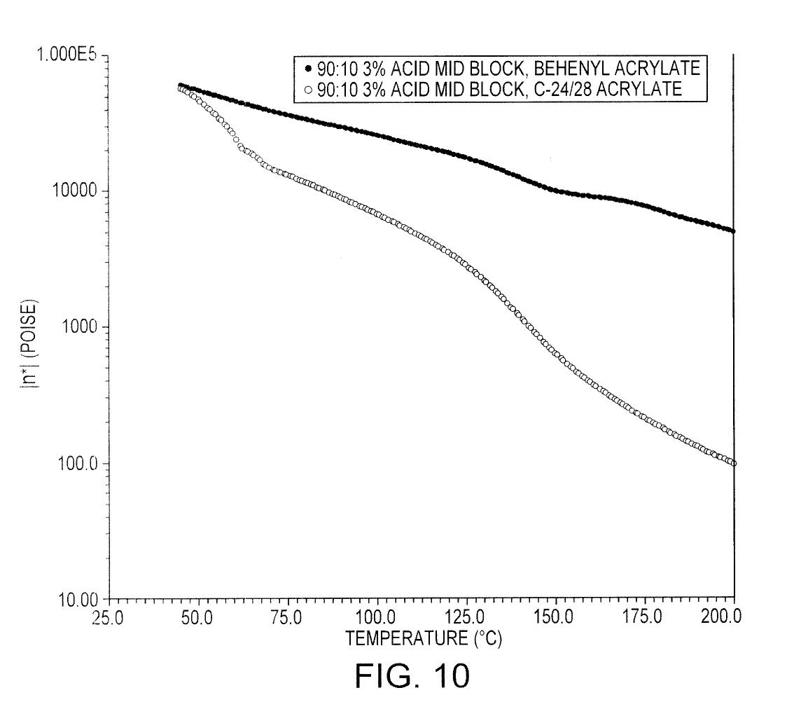

As previously mentioned and seen in FIG. 7, the C-24/28 containing block copolymer has a much lower modulus than the behenyl acrylate containing block copolymer. FIG. 10 is a plot of absolute viscosity as a function of temperature for the C-24/28 block copolymer compared to the behenyl block copolymer. Both polymers are 90:10 mid block to end block weight fraction, and contain 3% acrylic acid in the mid block.

The viscosity of the block copolymer containing the C-24/28 end blocks is much lower than the behenyl containing material, 10,000 cps compared to 500,000 cps respectively. This difference in melt viscosity could be because the C-24/28 material is approximately 30% higher in equivalency weight, resulting in a reduction in degree of polymerization. Although the materials are approximately 1.5 orders of magnitude different in viscosity at 200° C., suggesting some order/disorder transition, or synergistic viscosity reducing effect with the C-24/28 containing block copolymer.

Inherently pressure sensitive all acrylic block copolymers, and the elevation of the melting point of these materials has been demonstrated. This example details prototype materials that could potentially be useful as heat activatable adhesives and as a switchable prototype. Additionally the use of an AR-2000 rheometer has been demonstrated for melt viscosity analysis of hot melt materials.

Many other benefits will no doubt become apparent from future application and development of this technology.

All patents, published applications, and articles noted herein are hereby incorporated by reference in their entirety.

It will be understood that any one or more feature or component of one embodiment described herein can be combined with one or more other features or components of another embodiment. Thus, the present invention includes any and all combinations of components or features of the embodiments described herein.

As described hereinabove, the present invention solves many problems associated with previous type devices. However, it will be appreciated that various changes in the details, materials and arrangements of components, which have been herein described and illustrated in order to explain the nature of the invention, may be made by those skilled in the art without departing from the principle and scope of the invention, as expressed in the appended claims.

What is claimed is:

1. A stimuli-responsive polymer comprising an intermediate portion including acrylic and/or methacrylic monomers and opposite end blocks, each end block including a stimuli-responsive group selected from the group consisting of (i) a crystallizable side chain and (ii) an amorphous monomer having solubility parameters that are different than solubility parameters of monomers in the intermediate region, wherein the ratio of total molecular weight of the end blocks to the molecular weight of the intermediate portion of the polymer is from about 5:95 to about 40:60.

2. The stimuli-responsive polymer of claim 1 wherein the intermediate portion includes a majority proportion of 2-ethylhexyl acrylate.

3. The stimuli-responsive polymer of claim 1 wherein the stimuli-responsive group is a crystallizable side chain.

4. The stimuli-responsive polymer of claim 3 wherein the crystallizable side chain is a high aliphatic acrylic ester.

5. The stimuli-responsive polymer of claim 4 wherein the high aliphatic acrylic ester is a C₁₆-C₃₀ acrylic ester.

6. The stimuli-responsive polymer of claim 4 wherein the high aliphatic acrylic ester is behenyl acrylate.

7. The stimuli-responsive polymer of claim 1 wherein the stimuli-responsive group is an amorphous group having solubility parameters that are different from other monomers in the intermediate portion of the polymer to cause phase separation.

8. The stimuli-responsive polymer of claim 7 wherein the stimuli-responsive group is t-butyl acrylate.

9. The stimuli-responsive polymer of claim 1 wherein the polymer has a molecular weight of from about 25,000 to about 300,000.

10. The stimuli-responsive polymer of claim 9 wherein the polymer has a molecular weight of from about 50,000 to about 200,000.

11. The stimuli-responsive polymer of claim 10 wherein the polymer has a molecular weight of from about 75,000 to about 150,000.

12. The stimuli-responsive polymer of claim 1 wherein the polymer has a polydispersity of less than about 2.5.

13. The stimuli-responsive polymer of claim 12 wherein the polymer has a polydispersity of less than about 2.0.

14. The stimuli-responsive polymer of claim 13 wherein the polymer has a polydispersity of less than about 1.5.

15. The stimuli-responsive polymer of claim 1 wherein upon application of a stimulus, the polymer exhibits a change in at least one property selected from the group consisting of bulk viscoelastic properties, solution/colloidal properties, gas permeability, solvent/chemical resistance, melt rheology, optical properties, and combinations thereof.

16. The stimuli-responsive polymer of claim 15 wherein the stimulus is selected from the group consisting of temperature, pH, exposure to ultraviolet radiation, exposure to moisture, and combinations thereof.

17. An adhesive including a stimuli-responsive polymer comprising an intermediate portion including acrylic and/or methacrylic monomers and opposite end blocks, each end block including a stimuli-responsive group selected from the group consisting of (i) a crystallizable side chain and (ii) an amorphous monomer having solubility parameters that are different from solubility parameters of monomers in the intermediate region, wherein the ratio of total molecular weight of the end blocks to the molecular weight of the intermediate portion of the polymer is from about 5:95 to about 40:60.

18. The adhesive of claim 17 wherein the intermediate portion includes a majority proportion of 2-ethylhexyl acrylate.

19. The adhesive of claim 17 wherein the stimuli-responsive group is a crystallizable side chain.

20. The adhesive of claim 19 wherein the crystallizable side chain is a high aliphatic acrylic ester.

21. The adhesive of claim 20 wherein the high aliphatic acrylic ester is a C₁₆-C₃₀ acrylic ester.

22. The adhesive of claim 20 wherein the high aliphatic acrylic ester is behenyl acrylate.

23. The adhesive of claim 17 wherein the stimuli-responsive group is an amorphous group having solubility parameters that are different from other monomers in the intermediate portion of the polymer to cause phase separation.

24. The adhesive of claim 23 wherein the stimuli-responsive group is t-butyl acrylate.

25. The adhesive of claim 17 wherein the polymer has a molecular weight of from about 25,000 to about 300,000.

26. The adhesive of claim 25 wherein the polymer has a molecular weight of from about 50,000 to about 200,000.

27. The adhesive of claim 26 wherein the polymer has a molecular weight of from about 75,000 to about 150,000.

28. The adhesive of claim 17 wherein the polymer has a polydispersity of less than about 2.5.

29. The adhesive of claim 28 wherein the polymer has a polydispersity of less than about 2.0.

30. The adhesive of claim 29 wherein the polymer has a polydispersity of less than about 1.5.

31. The adhesive of claim 17 wherein upon application of a stimulus, the polymer exhibits a change in at least one property selected from the group consisting of bulk viscoelastic properties, solution/colloidal properties, gas permeability, solvent/chemical resistance, melt rheology, optical properties, and combinations thereof.

32. The adhesive of claim 31 wherein the stimulus is selected from the group consisting of temperature, pH, exposure to ultraviolet radiation, exposure to moisture, and combinations thereof.

33. The adhesive of claim 17 wherein the adhesive is a pressure sensitive adhesive.
